(19) United States
(12) Patent Application Publication
(10) Pub. No.: US 2026/0145538 A1
(43) Pub. Date: May 28, 2026

(54) RELAY DIAGNOSTIC APPARATUS

(71) Applicant: TOYOTA JIDOSHA KABUSHIKI KAISHA, Toyota-shi (JP)

(72) Inventors: Yasuaki OKABE, Toyota-shi (JP); Yoshihiro YAKU, Toyota-shi (JP); Atsushi SHINOHARA, Toyota-shi (JP)

(73) Assignee: TOYOTA JIDOSHA KABUSHIKI KAISHA, Toyota-shi (JP)

(21) Appl. No.: 19/392,723

(22) Filed: Nov. 18, 2025

(30) Foreign Application Priority Data
Nov. 22, 2024 (JP) 2024-204252

(51) Int. Cl. B60L 3/04; G07C 5/08; H02J 7/00

(52) U.S. Cl. CPC B60L 3/04; G07C 5/0808; H02J 7/855

(57) ABSTRACT

A vehicle power supply system includes a relay on a battery-side power line relative to a smoothing capacitor, a driver for the relay, first and second control units, and a cut-off line. The second control unit outputs a drive signal to the driver in response to a command from the first control unit, while the first control unit can directly cut off the relay through the cut-off line in preference to the drive signal from the second control unit. When terminating the system, the first control unit outputs a relay cut-off command to the second control unit, diagnoses relay welding based on whether the smoothing capacitor voltage decreases, then sets the cut-off line to a cut-off state, outputs a relay connection command to the second control unit, and diagnoses whether the cut-off line is effective by monitoring the driver’s output state.

### CROSS-REFERENCE TO RELATED APPLICATION

The present disclosure claims priority to Japanese Patent Application No. 2024-204252 filed on Nov. 22, 2024, which is incorporated herein by reference in its entirety including specification, drawings and claims.

### TECHNICAL FIELD

The present disclosure relates to the relay diagnostic apparatus.

### BACKGROUND

Conventionally, as the relay diagnostic device of this type, there has been proposed the electric vehicle provided with: the traveling motor; the inverter that drives the traveling motor; the battery that supplies power to the inverter; the first system main relay and the second system main relay that respectively open and close the pair of power supply lines connecting the battery and the inverter; the precharge relay that is connected in series with the precharge resistor in the electric circuit connected in parallel to the first system main relay; and the two device relays that respectively open and close the pair of branch lines branching from the pair of power supply lines, the vehicle being further equipped with the diagnostic processing unit that performs the welding diagnosis of the device relays (for example, see Patent Document 1). The diagnostic processing unit, during the processing period of the system startup, selects one of the two device relays as the diagnostic target, keeps the diagnostic target device relay and the first system main relay in the disconnected state, switches the other device relay (which is not the diagnostic target), the second system main relay, and the precharge relay from the disconnected state to the connected state, and then inspects whether the voltage between the pair of branch lines rises, thereby performing the welding diagnosis of one of the device relays.

Further, during the processing period at the end of the branch line usage, the diagnostic processing unit selects the other of the two device relays as the diagnostic target, keeps the first system main relay, the second system main relay, and the device relay other than the diagnostic target in the connected state, switches the diagnostic target device relay from the connected state to the disconnected state, and then inspects whether the voltage between the pair of branch lines decreases, thereby performing the welding diagnosis of the other device relay.

### Citation List

### Patent Literature

PTL1: JP2020-54160

### SUMMARY

In the electric vehicle provided with the drive unit, the battery, the smoothing capacitor attached to the power line from the battery to the drive unit, the relay attached to the power line on the battery side of the smoothing capacitor, and the driver that drives the relay, there is a configuration in which the cut-off line is connected from the control unit different from the control unit that outputs the drive signal to the driver, to the driver, so that the relay is directly cut off from this different control unit. In this vehicle, in addition to the welding diagnosis of the relay, it is desirable to diagnose whether the cut-off line functions effectively. The welding diagnosis of the relay at the time of the system stop is performed by turning off the relay and determining whether the voltage of the smoothing capacitor decreases. Therefore, if the cut-off line is set to the cut-off side while the relay is in the connected state, and whether the voltage of the smoothing capacitor decreases is used to diagnose whether the cut-off line functions effectively, it becomes necessary to reconnect the relay afterward in order to perform the welding diagnosis of the relay. As a result, the number of relay connections increases, and there is a risk that the lifetime of the relay may decrease.

The relay diagnostic apparatus of the present disclosure has the principal object of diagnosing whether the cut-off line is effective while the relay is in the cut-off state, without actually connecting the relay.

The relay diagnostic apparatus of the present disclosure has adopted the following means in order to achieve the above principal object.

The relay diagnostic apparatus of the present disclosure is a relay diagnostic apparatus in a vehicle drive system, the vehicle drive system including the drive unit, the battery, the smoothing capacitor attached to the power line from the battery to the drive unit, the relay attached to the power line on the battery side of the smoothing capacitor, the driver that drives the relay, the first control unit that controls the system, the second control unit that outputs the drive signal to the driver in response to the command from the first control unit, and the cut-off line that is connected from the first control unit to the driver, and that directly cuts off the relay in preference to the drive signal from the second control unit by being set to the cut-off side by the first control unit. The gist is that, when the first control unit shuts down the system by disconnecting the drive unit from the battery, the first control unit outputs the cut-off command of the relay to the second control unit, diagnoses the presence or absence of welding of the relay based on whether the voltage of the smoothing capacitor decreases, and then sets the state of the cut-off line to the cut-off side while outputting the connection command of the relay to the second control unit. By monitoring the output state of the driver, the apparatus diagnoses whether the cut-off line functions effectively.

In the relay diagnostic apparatus of the present disclosure, when the first control unit terminates the system by disconnecting the drive unit from the battery, the first control unit outputs the cut-off command of the relay to the second control unit and diagnoses the presence or absence of welding of the relay based on whether the voltage of the smoothing capacitor decreases. Thereafter, the first control unit sets the state of the cut-off line to the cut-off side and outputs the connection command of the relay to the second control unit, and by monitoring the output state of the driver, diagnoses whether the cut-off line functions effectively.

Accordingly, it is possible to diagnose whether the cut-off line functions effectively in a state where the relay is cut off, without actually connecting the relay. Furthermore, since the relay is in the connected state when the system is terminated by disconnecting the drive unit from the battery, the welding diagnosis of the relay can be performed first, and then the diagnosis of whether the cut-off line is effective can be performed, thereby eliminating the necessity of reconnecting the relay for the purpose of welding diagnosis.

In the relay diagnostic apparatus of the present disclosure, as the relay, the apparatus includes the first relay attached to one of the positive line and the negative line on the battery side of the smoothing capacitor of the power line, and the second relay attached to the other line, which is not provided with the first relay, among the positive line and the negative line. As the driver, the apparatus includes the first driver that drives the first relay and the second driver that drives the second relay. The first control unit, when terminating the system by disconnecting the drive unit from the battery, outputs the cut-off command of the first relay to the second control unit, diagnoses the presence or absence of welding of the first relay based on whether the voltage of the smoothing capacitor decreases, and when the diagnostic result indicates that there is no welding of the first relay, sets the state of the cut-off line to the cut-off side, outputs the connection command of the second relay to the second control unit, and when the output state of the second driver is in the output state to cut off the second relay, may diagnose that the cut-off line functions effectively. Since it has already been confirmed that the first relay is not welded and is cut off, even if there is an abnormality in the cut-off line and the second relay is connected by the connection command of the second relay, a closed circuit between the smoothing capacitor and the battery can be prevented from being formed. As a result, damage to the relay due to inrush current can be avoided.

In the relay diagnostic apparatus of the present disclosure, as the relay, the apparatus includes the first relay attached to one of the positive line and the negative line on the battery side of the smoothing capacitor of the power line, and the second relay attached to the other line, which is not provided with the first relay, among the positive line and the negative line, and further includes the precharge circuit in which the precharge resistor and the third relay for precharge are connected in series to bypass the second relay. As the driver, the apparatus includes the first driver that drives the first relay, the second driver that drives the second relay, and the third driver that drives the third relay. The first control unit, when terminating the system by disconnecting the drive unit from the battery, outputs the cut-off command of the second relay to the second control unit, and diagnoses the presence or absence of welding of the second relay based on whether the voltage of the capacitor decreases. When the diagnostic result indicates that there is no welding of the second relay, the first control unit sets the cut-off line to the cut-off side and outputs the connection command of the first relay to the second control unit, and when the output state of the first driver is in the output state to cut off the first relay, diagnoses that the cut-off line functions effectively with respect to the first driver. When the diagnostic result indicates that the cut-off line functions effectively with respect to the first driver, the first control unit outputs the connection command of the third relay to the second control unit, and diagnoses the presence or absence of welding of the first relay based on whether the voltage of the capacitor increases by the precharge. When the diagnostic result indicates that there is no welding of the first relay, the first control unit sets the cut-off line to the cut-off side, outputs the connection commands of the second relay and the third relay to the second control unit, and when the output state of the second driver is in the output state to cut off the second relay and the output state of the third driver is in the output state to cut off the third relay, diagnoses that the cut-off line functions effectively with respect to the second driver and the third driver. That is, the first control unit first outputs the cut-off command to the second relay, performs the welding diagnosis of the second relay, and after confirming that the second relay is not welded, sets the cut-off line to the cut-off side and outputs the connection command of the first relay, thereby diagnosing whether the cut-off line functions effectively with respect to the first driver. As a result, even if the third relay is welded and there is an abnormality in the cut-off line, and the first relay is connected by the connection command of the first relay, only a closed circuit through the precharge resistor is formed between the battery and the smoothing capacitor, and inrush current is prevented from occurring in the power line. Further, the first control unit outputs the connection command of the third relay, performs the welding diagnosis of the first relay (diagnosis of whether the voltage of the smoothing capacitor increases by the precharge), confirms that the first relay is not welded and is cut off, and then sets the cut-off line to the cut-off side, outputs the connection commands of the second relay and the third relay, and diagnoses whether the cut-off line functions effectively with respect to the second driver and the third driver. As a result, even if there is an abnormality in the cut-off line and the second relay or the third relay is connected by the connection commands, the closed circuit between the battery and the smoothing capacitor can be prevented from being formed. In addition, since the cut-off line is diagnosed collectively with respect to the second driver and the third driver, the time required for diagnosis can be reduced.

### BRIEF DESCRIPTION OF DRAWINGS

FIG. 1 is a schematic configuration diagram of a vehicle drive system including a relay diagnostic apparatus according to the present disclosure.

FIG. 2 is a flowchart illustrating an example of diagnostic processing.

FIG. 3 is a schematic configuration diagram of a vehicle drive system including another relay diagnostic apparatus.

FIG. 4 is a flowchart illustrating another diagnostic processing.

FIG. 5 is a flowchart illustrating another related diagnostic processing.

### DETAILED DESCRIPTION OF EMBODIMENTS

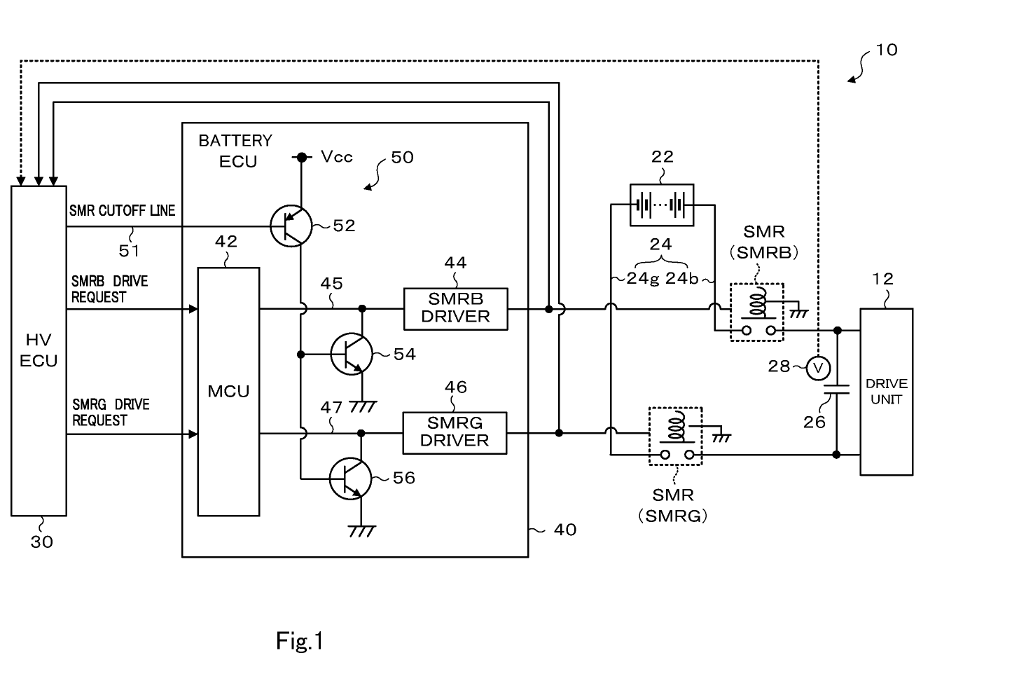

Next, embodiments for carrying out the present disclosure will be described. FIG. 1 is the schematic configuration diagram of the vehicle drive system 10 including the relay diagnostic apparatus of the present disclosure. The vehicle drive system 10 includes the drive unit 12, the battery 22, the capacitor 26, the system main relay (SMR), the hybrid electronic control unit (hereinafter referred to as "the HVECU") 30, and the battery electronic control unit (hereinafter referred to as "the battery ECU") 40.

The battery 22 is constituted, for example, by the lithium-ion secondary battery or the nickel-metal hydride secondary battery, and is connected to the drive unit 12 having the engine and the motor through the power line 24. The capacitor 26 is connected to the positive line 24b and the negative line 24g of the power line 24, and smooths the voltage between the positive line 24b and the negative line 24g.

The system main relay (SMR) is attached to the battery side of the capacitor 26 of the power line 24. The system main relay (SMR) is constituted by the positive relay (SMRB) attached to the positive line 24b and the negative relay (SMRG) attached to the negative line 24g.

The HVECU 30, although not illustrated, is constituted as the microprocessor centered on the CPU, and in addition to the CPU, is provided with the ROM that stores the processing program and the like, the RAM that temporarily stores data, the input port, the output port, and the communication port. The HVECU 30 inputs signals from various sensors that detect the states of the engine and the motor included in the drive unit 12, generates the control signal based on the signals input from the various sensors, and outputs the control signal to the driving section of the engine and the motor. The HVECU 30 also inputs the capacitor voltage Vc from the voltage sensor 28 attached between the terminals of the capacitor 26. Furthermore, the HVECU 30 communicates with the battery ECU 40 via the communication port.

The battery ECU 40 includes the microcomputer (hereinafter referred to as "MCU") 42 having the CPU, the ROM, the RAM, the input port, the output port, and the communication port, the positive relay driving driver (hereinafter referred to as "the SMRB driving driver") 44, the negative relay driving driver (hereinafter referred to as "the SMRG driving driver") 46, and the relay cut-off circuit 50. The MCU 42 communicates with the HVECU 30 and, in response to the command from the HVECU 30, outputs the signal to the SMRB driving driver 44 and the SMRG driving driver 46. That is, when the connection command of the positive relay SMRB is input from the HVECU 30, the MCU 42 outputs high to the SMRB driving driver 44 through the signal line 45, and when the cut-off command of the positive relay SMRB is input from the HVECU 30, the MCU 42 outputs low to the SMRB driving driver 44 through the signal line 45. The SMRB driving driver 44 connects the positive relay SMRB when the high output signal is input from the MCU 42, and cuts off the positive relay SMRB when the low output signal is input from the MCU 42. Further, when the connection command of the negative relay SMRG is input from the HVECU 30, the MCU 42 outputs high to the SMRG driving driver 46 through the signal line 47, and when the cut-off command of the negative relay SMRG is input from the HVECU 30, the MCU 42 outputs low to the SMRG driving driver 46 through the signal line 47. The SMRG driving driver 46 connects the negative relay SMRG when the high output signal is input from the MCU 42, and cuts off the negative relay SMRG when the low output signal is input from the MCU 42.

The relay cut-off circuit 50 directly cuts off the positive relay SMRB and the negative relay SMRG from the HVECU 30, and as shown in FIG. 1, includes the transistors 52, 54, and 56. The relay cut-off circuit 50 is also provided with the resistors and the capacitors, although these are omitted from the illustration. The base side of the transistor 52 is connected to the output port of the HVECU 30 through the system main relay cut-off line (hereinafter referred to as "the SMR cut-off line") 51, the emitter side of the transistor 52 is connected to the voltage source Vcc, and the collector side of the transistor 52 is connected to the base side of the transistor 54 and the base side of the transistor 56. The collector side of the transistor 54 is connected to the signal line 45 from the MCU 42 to the SMRB driving driver 44, and the emitter side of the transistor 54 is grounded. The collector side of the transistor 56 is connected to the signal line 47 from the MCU 42 to the SMRG driving driver 46, and the emitter side of the transistor 56 is grounded. Accordingly, when the HVECU 30 outputs high to the SMR cut-off line 51, even if the MCU 42 outputs high, the potentials of the signal lines 45 and 47 fall to ground, so that the SMRB driving driver 44 and the SMRG driving driver 46 receive the low output signals, and the positive relay SMRB and the negative relay SMRG are cut off. Therefore, the HVECU 30 can directly cut off the system main relay SMR in an emergency, such as when a failure occurs in the MCU 42 of the battery ECU 40.

In the vehicle drive system 10 of the present embodiment, when the start switch is turned on, the on-signal is input to the power supply ECU (not shown), and the ST signal is output from the power supply ECU to the HVECU 30. The HVECU 30, having received the ST signal, checks whether there is an abnormality in the drive unit 12 and the like, then performs the precharge of the capacitor 26, outputs the connection command of the positive relay SMRB and the connection command of the negative relay SMRG to the battery ECU 40, and connects the positive relay SMRB and the negative relay SMRG. The precharge of the capacitor 26 can be performed, for example, by boosting the power from the auxiliary battery connected to the power line 24 through the DC/DC converter and supplying it to the capacitor 26. Thereafter, the HVECU 30 outputs the READY signal, which indicates that the system startup has been completed, to the power supply ECU. In this manner, the startup of the system is completed.

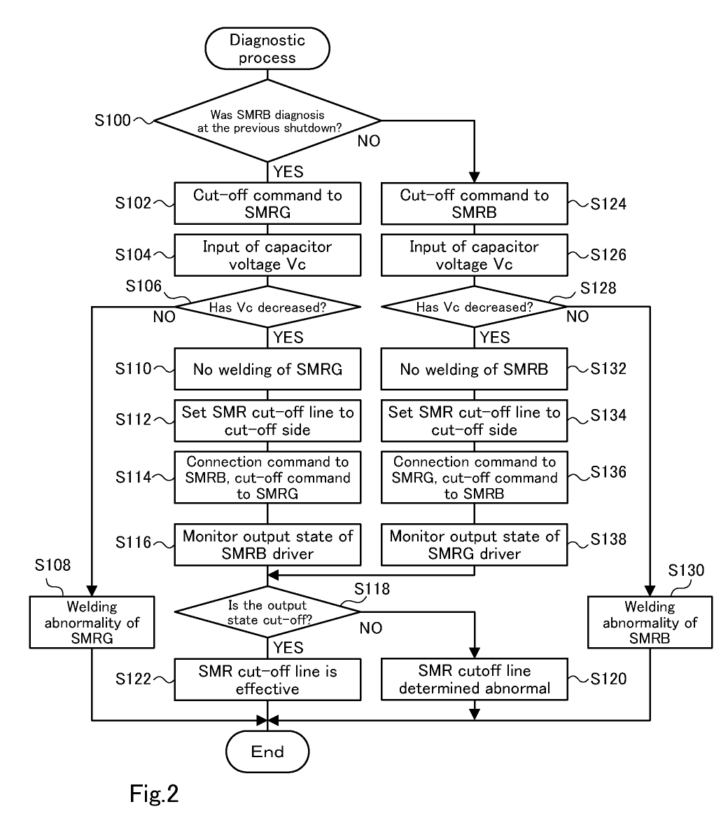

Next, the welding diagnosis of the system main relay SMR and the diagnosis of the SMR cut-off line 51, which are performed when the system main relay SMR is cut off at the time of system stop, will be described. FIG. 2 is the flowchart showing an example of the diagnostic process executed by the HVECU 30. The welding diagnosis of the system main relay SMR is performed by cutting off one of the positive relay SMRB and the negative relay SMRG at the time of system stop, discharging the capacitor 26, and determining whether the capacitor voltage Vc from the voltage sensor 28 has decreased. The discharge of the capacitor 26 can be carried out by consuming it as heat with the equipment included in the drive unit 12. In the present embodiment, the welding diagnosis of the positive relay SMRB and the welding diagnosis of the negative relay SMRG are alternately executed one at a time for each system stop.

When the diagnostic process is executed, the HVECU 30 first determines whether the welding diagnosis of the positive relay SMRB was executed at the previous system stop (S100). If the HVECU 30 determines that the welding diagnosis of the positive relay SMRB was executed at the previous system stop, it decides to execute the welding diagnosis of the negative relay SMRG at the current system stop, and outputs the cut-off command of the negative relay SMRG to the MCU 42 of the battery ECU 40 through communication (S102). The MCU 42, having received the cut-off command, outputs low to the SMRG driving driver 46 and thereby cuts off the negative relay SMRG. Then, the HVECU 30 inputs the capacitor voltage Vc from the voltage sensor 28 (S104), and determines whether the input capacitor voltage Vc has decreased (S106). If the HVECU 30 determines that the capacitor voltage Vc has not decreased, it judges that the abnormality due to welding has occurred in the negative relay SMRG (S108), and terminates the diagnostic process.

On the other hand, when the HVECU 30 determines that the capacitor voltage Vc has decreased, it judges that the negative relay SMRG has been normally cut off and is not welded (S110), and then performs the diagnosis of the SMR cut-off line 51. That is, the HVECU 30 sets the SMR cut-off line 51 to the cut-off side (S112), outputs the connection command of the positive relay SMRB and the cut-off command of the negative relay SMRG to the MCU 42 of the battery ECU 40 through communication (S114), and monitors the output state of the SMRB driving driver 44 (S116).

When the HVECU 30 determines that the output state of the SMRB driving driver 44 is not the output state to cut off the positive relay SMRB (NO in S118), it judges that the SMR cut-off line 51 is not functioning effectively with respect to the SMRB driving driver 44 and that an abnormality has occurred (S120), and terminates the diagnostic process. On the other hand, when the HVECU 30 determines that the output state of the SMRB driving driver 44 is the output state to cut off the positive relay SMRB (YES in S118), it judges that the SMR cut-off line 51 is functioning effectively with respect to the SMRB driving driver 44 (S122), and terminates the diagnostic process.

When the HVECU 30 determines in S100 that the welding diagnosis executed at the previous system stop was for the negative relay SMRG rather than the positive relay SMRB, it judges that the welding diagnosis of the positive relay SMRB is to be executed at the current system stop, and outputs the cut-off command of the positive relay SMRB to the MCU 42 of the battery ECU 40 through communication (S124). The MCU 42, having received the cut-off command, outputs low to the SMRB driving driver 44 and thereby cuts off the positive relay SMRB. Then, the HVECU 30 inputs the capacitor voltage Vc from the voltage sensor 28 (S126), and determines whether the input capacitor voltage Vc has decreased (S128). If the HVECU 30 determines that the capacitor voltage Vc has not decreased, it judges that an abnormality due to welding has occurred in the positive relay SMRB (S130), and terminates the diagnostic process.

On the other hand, when the HVECU 30 determines that the capacitor voltage Vc has decreased, it judges that the positive relay SMRB has been normally cut off and is not welded (S132), and then performs the diagnosis of the SMR cut-off line 51. That is, the HVECU 30 sets the SMR cut-off line 51 to the cut-off side (S134), outputs the connection command of the negative relay SMRG and the cut-off command of the positive relay SMRB to the battery ECU 40 through communication (S136), and monitors the output state of the SMRG driving driver 46 (S138). When the HVECU 30 determines that the output state of the SMRG driving driver 46 is not the output state to cut off the negative relay SMRG (NO in S118), it judges that the SMR cut-off line 51 is not functioning effectively with respect to the SMRG driving driver 46 and that an abnormality has occurred (S120), and terminates the diagnostic process. On the other hand, when the HVECU 30 determines that the output state of the SMRG driving driver 46 is the output state to cut off the negative relay SMRG (YES in S118), it judges that the SMR cut-off line 51 is functioning effectively with respect to the SMRG driving driver 46 (S122), and terminates the diagnostic process.

As described above, at the time of system stop, the HVECU 30 executes the welding diagnosis of one of the positive relay SMRB and the negative relay SMRG by outputting the cut-off command to the MCU 42 of the battery ECU 40 and cutting off the corresponding one of the relays. In addition, after confirming that the corresponding relay is not welded and has been normally cut off, the HVECU 30 sets the SMR cut-off line 51 to the cut-off side, outputs the connection command of the other one of the positive relay SMRB and the negative relay SMRG to the MCU 42 of the battery ECU 40, and executes the diagnosis of whether the SMR cut-off line 51 functions effectively with respect to the other relay. Therefore, reconnection of the positive relay SMRB or the negative relay SMRG for the purpose of diagnosis is unnecessary, and it is possible to suppress the reduction of the lifetime caused by the increase in the number of connections of the positive relay SMRB or the negative relay SMRG. Furthermore, since it is confirmed that one of the relays is not welded and is normally cut off, even if there is an abnormality in the SMR cut-off line 51 and the other relay is connected by the connection command from the HVECU 30, it is possible to prevent a closed circuit from being formed between the battery 22 and the capacitor 26.

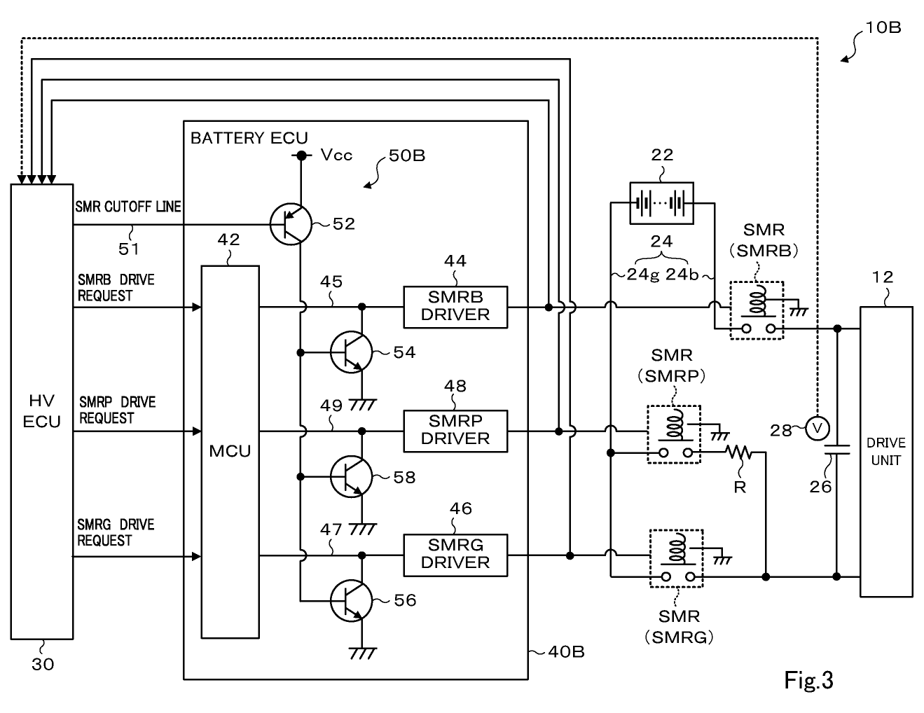

Next, the relay diagnostic apparatus according to another embodiment will be described. FIG. 3 is the schematic configuration diagram of the vehicle drive system 10B including the relay diagnostic apparatus according to another embodiment. As shown, in the vehicle drive system 10B, the system main relay SMR, in addition to the positive relay SMRB and the negative relay SMRG, is provided with the precharge circuit in which the precharge resistor R and the precharge relay SMRP are connected in series to bypass the negative relay SMRG on the negative line 24g of the power line 24.

In addition to the SMRB driving driver 44 and the SMRG driving driver 46, the battery ECU 40B is provided with the precharge relay driving driver (hereinafter referred to as "the SMRP driving driver") 48, which connects the precharge relay SMRP when the high output signal is input from the MCU 42, and cuts off the precharge relay SMRP when the low output signal is input from the MCU 42. Furthermore, the battery ECU 40B is provided with the relay cut-off circuit 50B having, in addition to the transistors 52, 54, and 56, the transistor 58 whose base side is connected to the collector side of the transistor 52. The collector side of the transistor 58 is connected to the signal line 49 from the MCU 42 to the SMRP driving driver 48, and the emitter side of the transistor 58 is grounded. Accordingly, when the HVECU 30 outputs high to the SMR cut-off line 51, even if the MCU 42 outputs high, the potentials of the signal lines 45, 47, and 49 fall to ground, so that the SMRB driving driver 44, the SMRG driving driver 46, and the SMRP driving driver 48 receive the low output signals, and the positive relay SMRB, the negative relay SMRG, and the precharge relay SMRP are cut off.

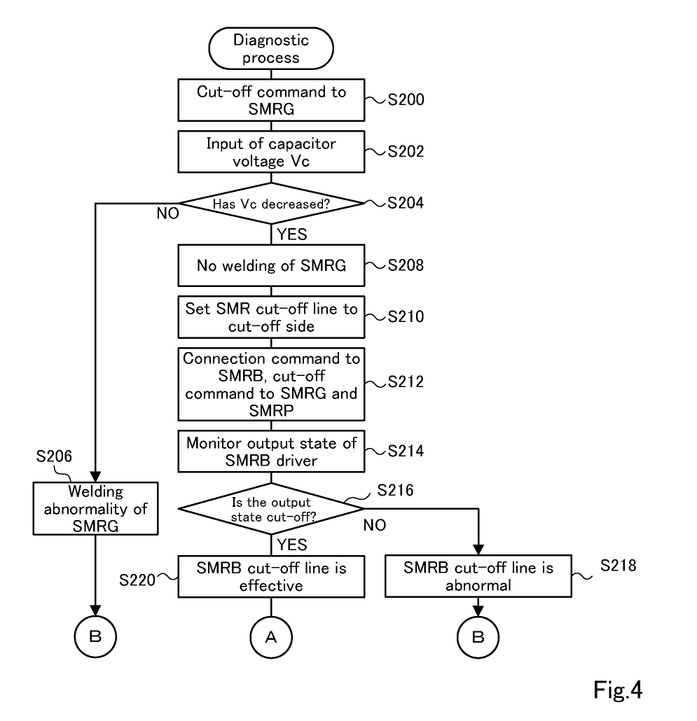

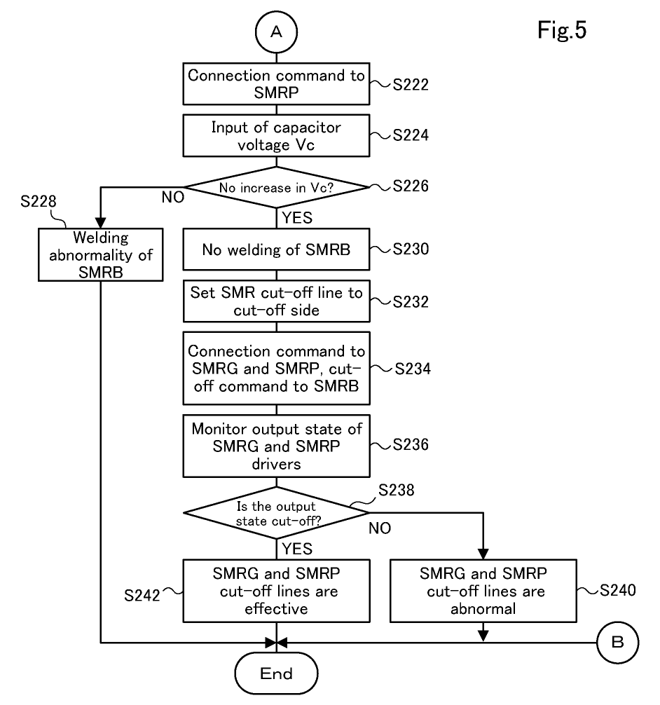

FIGS. 4 and 5 are flowcharts showing the diagnostic processes according to another embodiment. In the other embodiment, the welding diagnosis of the negative relay SMRG, the diagnosis of whether the SMR cut-off line 51 functions effectively with respect to the positive relay SMRB, the welding diagnosis of the positive relay SMRB, and the diagnosis of whether the SMR cut-off line 51 functions effectively with respect to the negative relay SMRG and the precharge relay SMRP are executed in this order.

When the diagnostic process is executed, the HVECU 30 first performs the welding diagnosis of the negative relay SMRG (S200–S208) by the processing similar to S102–S110 of the diagnostic process of FIG. 2. When the HVECU 30 confirms that the negative relay SMRG is not welded, it performs the diagnosis of whether the SMR cut-off line 51 functions effectively with respect to the SMRB driving driver 44 (S210–S220) by the processing similar to S112–S122 of the diagnostic process of FIG. 2.

When it is confirmed that the SMR cut-off line 51 functions effectively with respect to the SMRB driving driver 44, the HVECU 30 outputs the connection command of the precharge relay SMRP to the MCU 42 of the battery ECU 40 through communication (S222). Subsequently, the HVECU 30 inputs the capacitor voltage Vc from the voltage sensor 28 (S224) and determines whether the input capacitor voltage Vc has increased (S226). When the HVECU 30 determines that the capacitor voltage Vc has increased, it judges that an abnormality due to welding has occurred in the positive relay SMRB (S228), and terminates the diagnostic process. Here, in S200–S208, the negative relay SMRG has been cut off by the cut-off command from the HVECU 30 to the MCU 42 of the battery ECU 40, and at that time it was confirmed that no abnormality due to welding had occurred, since the capacitor voltage Vc decreased. If the positive relay SMRB is not welded and the SMR cut-off line 51 functions effectively, the positive relay SMRB is cut off by S210 and S212, and therefore, even if the precharge relay SMRP is connected thereafter, the capacitor voltage Vc does not increase. Accordingly, by connecting the precharge relay SMRP and determining whether the capacitor voltage Vc increases, it is possible to diagnose whether the positive relay SMRB is welded. Even if the positive relay SMRB is welded, since the precharge relay SMRP is connected, the power of the battery 22 is supplied to the capacitor 26 through the precharge resistor R, and therefore no inrush current occurs in the power line 24.

On the other hand, when the HVECU 30 determines that the capacitor voltage Vc has not increased, it judges that the positive relay SMRB has been normally cut off and is not welded (S230), and then performs the diagnosis of the SMR cut-off line 51. That is, the HVECU 30 sets the SMR cut-off line 51 to the cut-off side (S232), outputs the connection command of the negative relay SMRG, the connection command of the precharge relay SMRP, and the cut-off command of the positive relay SMRB to the battery ECU 40 through communication (S234), and monitors the output state of the SMRG driving driver 46 and the output state of the SMRP driving driver 48 (S236). When the HVECU 30 determines that the output state of the SMRG driving driver 46 is not the output state to cut off the negative relay SMRG, or that the output state of the SMRP driving driver 48 is not the output state to cut off the precharge relay SMRP (NO in S238), it judges that the SMR cut-off line 51 is not functioning effectively with respect to the SMRG driving driver 46 or the SMRP driving driver 48, and that an abnormality has occurred (S240), and terminates the diagnostic process. Here, the positive relay SMRB has been cut off by S210 and S212, and it has been confirmed that no abnormality due to welding has occurred. Therefore, even if there is an abnormality in the SMR cut-off line 51 and the negative relay SMRG is connected by the connection command output from the HVECU 30 to the MCU 42 of the battery ECU 40 in S234, no closed circuit is formed between the battery 22 and the capacitor 26, and no inrush current occurs in the power line 24.

On the other hand, when the HVECU 30 determines that the output state of the SMRG driving driver 46 is the output state to cut off the negative relay SMRG, and further that the output state of the SMRP driving driver 48 is the output state to cut off the precharge relay SMRP (YES in S238), it judges that the SMR cut-off line 51 is functioning effectively with respect to the SMRG driving driver 46 and the SMRP driving driver 48 (S242), and terminates the diagnostic process.

As described above, at the time of system stop, the HVECU 30 executes the welding diagnosis of the negative relay SMRG by outputting the cut-off command to the MCU 42 of the battery ECU 40 to cut off the negative relay SMRG, and after confirming that the negative relay SMRG is not welded and is normally cut off, sets the SMR cut-off line 51 to the cut-off side, outputs the connection command of the positive relay SMRB to the MCU 42 of the battery ECU 40, and executes the diagnosis of whether the SMR cut-off line 51 functions effectively with respect to the positive relay SMRB. Since it has been confirmed that the negative relay SMRG is not welded and is normally cut off, even if there is an abnormality in the SMR cut-off line 51 and the positive relay SMRB is connected by the connection command from the HVECU 30, it is possible to prevent a closed circuit from being formed between the battery 22 and the capacitor 26. Then, the HVECU 30 executes the welding diagnosis of the positive relay SMRB by outputting the connection command to the battery ECU 40 to connect the precharge relay SMRP, and after confirming that the positive relay SMRB is not welded and is normally cut off, sets the SMR cut-off line 51 to the cut-off side, outputs the connection commands of the negative relay SMRG and the precharge relay SMRP to the MCU 42 of the battery ECU 40, and executes the diagnosis of whether the SMR cut-off line 51 functions effectively with respect to the negative relay SMRG and the precharge relay SMRP. Since it has been confirmed that the positive relay SMRB is not welded and is normally cut off, even if there is an abnormality in the SMR cut-off line 51 and the negative relay SMRG or the precharge relay SMRP is connected by the connection command from the HVECU 30, it is possible to prevent a closed circuit from being formed between the battery 22 and the capacitor 26.

In another embodiment, the HVECU 30 sequentially executes the welding diagnosis of the negative relay SMRG, the diagnosis of whether the SMR cut-off line 51 functions effectively with respect to the positive relay SMRB, the welding diagnosis of the positive relay SMRB, and the diagnosis of whether the SMR cut-off line 51 functions effectively with respect to the negative relay SMRG and the precharge relay SMRP. However, the HVECU 30 may execute the welding diagnosis of the negative relay SMRG and the welding diagnosis of the positive relay SMRB first, and thereafter sequentially execute the diagnosis of whether the SMR cut-off line 51 functions effectively with respect to the positive relay SMRB, and the diagnosis of whether the SMR cut-off line 51 functions effectively with respect to the negative relay SMRG and the precharge relay SMRP. In this case, after performing the welding diagnosis of the negative relay SMRG, the HVECU 30 may execute the welding diagnosis of the positive relay SMRB by outputting the cut-off command of the positive relay SMRB to the MCU 42 of the battery ECU 40 and then outputting the connection command of the precharge relay SMRP to the MCU 42 of the battery ECU 40. It should be noted that the diagnosis of whether the SMR cut-off line 51 functions effectively with respect to the positive relay SMRB, and the diagnosis of whether the SMR cut-off line 51 functions effectively with respect to the negative relay SMRG and the precharge relay SMRP, may be alternately executed at each system stop.

In the above-described other embodiment, the precharge circuit (the precharge resistor R and the precharge relay SMRP) is connected in parallel with the negative relay SMRG, but it may also be connected in parallel with the positive relay SMRB.

As described above, embodiments have been explained with reference to examples regarding the mode for carrying out the present disclosure, but the present disclosure is not limited to such embodiments, and it is needless to say that various modes can be implemented within the scope not departing from the gist of the present disclosure.

### Industrial Applicability

The present disclosure is applicable to the manufacturing industry of the relay diagnostic apparatus.

1. A relay diagnostic apparatus in a vehicle drive system comprising:
a drive device;
a battery;
a smoothing capacitor attached to a power line from the battery to the drive device;
a relay attached to the power line on a battery side of the smoothing capacitor;
a driver for driving the relay;
a first control unit for controlling the system;
a second control unit is configured to output a drive signal to the driver based on a command from the first control unit; and
a cut-off line connected from the first control unit to the driver and set to a cut-off side by the first control unit so as to directly cut off the relay in preference to the drive signal from the second control unit to the driver,
wherein the first control unit, when disconnecting the battery from the drive device to terminate the system, is configured to output a cut-off command of the relay to the second control unit, diagnose whether the relay is welded based on whether a voltage of the smoothing capacitor decreases, and thereafter set a state of the cut-off line to the cut-off side, output a connection command of the relay to the second control unit, and diagnose whether the cut-off line functions effectively by monitoring an output state of the driver.

2. The relay diagnostic apparatus according to claim 1, comprising:
a first relay attached to one of a positive line and a negative line of the power line on the battery side of the smoothing capacitor; and
a second relay attached to the other of the positive line and the negative line of the power line to which the first relay is not attached;
wherein the driver comprises: a first driver for driving the first relay; and a second driver for driving the second relay;
and wherein the first control unit, when disconnecting the battery from the drive device to terminate the system, is configured to output a cut-off command of the first relay to the second control unit, diagnose whether the first relay is welded based on whether the voltage of the smoothing capacitor decreases, and when a diagnostic result indicating that the first relay is not welded is obtained, set the state of the cut-off line to the cut-off side, output a connection command of the second relay to the second control unit, and diagnose that the cut-off line functions effectively when the output state of the second driver is an output state to cut off the second relay.

3. The relay diagnostic apparatus according to claim 1, comprising:
a first relay attached to one of a positive line and a negative line of the power line on the battery side of the smoothing capacitor;
a second relay attached to the other of the positive line and the negative line of the power line to which the first relay is not attached; and
a precharge circuit comprising a precharge resistor and a third relay for precharge connected in series so as to bypass the second relay;
wherein the driver comprises: a first driver for driving the first relay; a second driver for driving the second relay; and a third driver for driving the third relay;
and wherein the first control unit, when disconnecting the battery from the drive device to terminate the system, is configured to output a cut-off command of the second relay to the second control unit, diagnose whether the second relay is welded based on whether a voltage of the capacitor decreases, and when a diagnostic result indicating that the second relay is not welded is obtained, set the cut-off line to the cut-off side, output a connection command of the first relay to the second control unit, and diagnose that the cut-off line functions effectively with respect to the first driver when an output state of the first driver is an output state to cut off the first relay, and when a diagnostic result indicating that the cut-off line functions effectively with respect to the first driver is obtained, output a connection command of the third relay to the second control unit, diagnose whether the first relay is welded based on whether the voltage of the capacitor increases, and when a diagnostic result indicating that the first relay is not welded is obtained, set the cut-off line to the cut-off side, output connection commands of the second relay and the third relay to the second control unit, and diagnose that the cut-off line functions effectively with respect to the second driver and the third driver when the output state of the second driver is an output state to cut off the second relay and the output state of the third driver is an output state to cut off the third relay.
